(19) United States
(12) Patent Application Publication
(10) Pub. No.: US 2014/0040807 A1
(43) Pub. Date: Feb. 6, 2014

(54) System, Method, and Computer Medium Having Computer Program Stored Thereon to Provide User Access to Consolidated, Interconnected Facility Equipment Information and Operating Status

(71) Applicant: COMFORT SYSTEMS USA ENERGY SERVICES, Windsor, CT (US)

(72) Inventor: Stephen R. Heard, Fayetteville, AR (US)

(73) Assignee: COMFORT SYSTEMS USA ENERGY SERVICES, Windsor, CT (US)

(21) Appl. No.: 13/786,536

(22) Filed: Mar. 6, 2013

Related U.S. Application Data
(60) Provisional application No. 61/678,029, filed on Jul. 31, 2012.

(51) Int. Cl. G06F 3/0484

(52) U.S. Cl. CPC G06F 3/0484
USPC 715/771

(57) ABSTRACT

One or more interconnected facility equipment databases store one or more interconnected facility equipment data files predetermined for a specific facility. The interconnected facility equipment data files include facility location data files and facility equipment data files associated with equipment located within a facility to indicate operating status of the equipment, separate from control of facility equipment, in specific facility locations during operation. A facility maintenance user accesses the interconnected facility equipment data for maintenance, repair, or operating status purposes. The facility maintenance user accesses the data through a graphical user interface readily navigable by the facility maintenance user in a direct, interrelated, non-sequential, and non-ordered arrangement of user selections so as to define a multidimensional lattice arrangement, thereby allowing freedom of movement within the multidimensional lattice arrangement.

### RELATED APPLICATIONS

This application is a non-provisional of and claims the benefit and priority to U.S. Provisional Patent Application No. 61/678,029 titled “System, Method, and Computer Medium Having Computer Program Stored Thereon to Provide User Access to Consolidated, Interconnected Facility Equipment Information and Operating Status” filed Jul. 31, 2012, which is incorporated herein by reference in its entirety.

### BACKGROUND

1. Field of Invention

The present invention relates generally to facility equipment and, more particularly, to systems, non-transitory computer-readable medium having computer program stored thereon, and computer-Implemented methods to provide information about equipment in facilities.

2. Related Art

Facility equipment systems such as heating, ventilation, and air conditioning (HVAC) systems, for example, have a large number of and many different components. The large number of components in the HVAC system of a given building within a facility can cause the system to be complex because the different components are located throughout the facility. Additionally, the proper functioning of one piece of equipment may depend on the proper functioning of another. To perform maintenance on an HVAC system, for example, maintenance personnel often have to be capable of understanding these relationships between components and may not know even where to find a given piece of equipment. Furthermore, the layout of the facility itself adds to this complexity. For example, one piece of HVAC equipment might serve several rooms within a facility, and that same piece of equipment might depend on the proper functioning of a second piece of equipment. To determine why the HVAC system is not properly heating or cooling a given room, maintenance personnel must first determine what equipment serves the room. Then, maintenance personnel gather more data: they must determine the other equipment on which that equipment depends to function properly, as well as the location of each piece of equipment. After going through these time-consuming data-gathering steps, they finally must determine the source of the problem or problems. The lengthy process of evaluating maintenance tasks in light of these interconnections—understanding the layout of a facility, determining the location of the HVAC system's components, and identifying the relationships between its components—can present a challenge for maintenance personnel who are on site at the facility. And HVAC systems are just one example and are not the only systems they must monitor. Furthermore, some maintenance personnel may work in many locations and sometimes have to travel to perform tasks related to facility systems. It is apparent that facility maintenance personnel face numerous challenges in ensuring that the facility's systems function properly and when needed.

### SUMMARY OF INVENTION

In view of the foregoing, Applicant has recognized one or more sources of problems of perpetual inefficiency in gaining access to needed facility systems information. Accordingly, the present invention advantageously provides enhanced systems, methods, and non-transitory computer-readable medium having computer program stored thereon to provide access to interconnected, consolidated facility equipment data through one tool. The challenges facing on-site maintenance personnel identified above are intensified because, often, they have access only to hard copies of building plans, system diagrams, maintenance manuals, and other information sources. To determine the location of a piece of equipment they are seeking or other equipment related to it, they must refer to these hard copies and manually search through multiple, discrete sources for the information they need.

For example, if a certain room became too warm, they might first refer to a hard-copy HVAC system diagram to determine which air conditioning unit serves that room. They would then need to trace that unit's connections through the system diagram to determine the other equipment related to it. Next, they would need to look at the building plans—another hard-copy source—to determine the location of each piece of equipment within the facility. They would then go to each location to check whether each piece of equipment is functioning properly until the source of the problem can be identified. Furthermore, they might wish to check the status of other equipment or conditions in rooms that depend on the proper functioning of that piece of equipment, so as to determine the full scope of the malfunction's effects. The task of locating each piece of equipment could be challenging if they have not seen it before or are unfamiliar with a piece of equipment's physical appearance. But even after the problematic piece of equipment is identified, the maintenance personnel's work is not complete: they must then refer to the building manual to identify that piece of equipment's manufacturer, model number, and other details to determine how to properly repair it. They might also need to look through a maintenance log to determine when that piece of equipment was last inspected or if it has experienced other malfunctions in the past. Finally, after spending an enormous amount of time gathering all of this information from multiple and unrelated hard-copy sources, maintenance personnel would need to analyze the information to determine the interconnections between the equipment and other equipment and between the equipment and the facility. Only after they have completed all of these time-consuming tasks could they make repairs to the malfunctioning equipment.

This lengthy process causes inefficient use of maintenance personnel's time and in delays in repairing HVAC system components, for example, which in turn causes discomfort to the facility's occupants. Moreover, the wasted time is unnecessary: the tasks of gathering data and determining the interconnected relationships between and among the data could be accomplished before the maintenance user begins the process of addressing a maintenance issue. Providing a maintenance user with readily accessible, interconnected data will improve the efficiency of a facility's HVAC maintenance process, and the present invention provides systems, non-transitory computer-readable medium having computer program stored thereon, and computer-implemented methods to accomplish that goal.

According to embodiments of the present invention, for example, a facility maintenance user can use a web browser on the facility maintenance user computer to access interconnected information about a building within a facility and its HVAC system in a manner readily navigable by the facility maintenance user in a direct, interrelated, non-sequential, and non-ordered arrangement of user selections: a multidimensional lattice arrangement.

Embodiments of the present invention provide, for example, a system to provide access to interconnected facility equipment data. In some embodiments, the system includes a first computer associated with an equipment operating status data administrator (“an equipment operating status server”). The equipment operating status server may have one or more processors, non-transitory computer-readable memory, and an input and output unit in communication with the one or more processors and adapted to communicate with an electronic communications network.

Additionally, some embodiments of the system include one or more interconnected facility equipment databases. The databases are positioned in communication with an electronic communications network and the equipment operating status server to store one or more interconnected facility equipment data files that have been predetermined for a specific facility. The interconnected facility equipment data files are defined by facility location data files and facility equipment data files associated with equipment located within a facility to indicate operating status of the equipment. In this embodiment, operating status is separate from control of facility equipment in specific facility locations during operation and includes one or more of the following: equipment manufacturer information, graphical representation of equipment's appearance, room number of equipment's location, floor number of equipment's location, locations within a facility served by equipment, other equipment on which equipment depends to function properly, and other equipment which depends on the proper functioning of equipment.

In some embodiments, the system also includes a second computer associated with a facility equipment data administrator (“a facility equipment data administrator computer”). The facility data equipment administrator computer serves to provide administrative access to facility equipment data. It also serves to provide facility equipment data to the one or more interconnected facility equipment databases. The facility equipment data administrator computer may have one or more processors, memory, and an input and output unit in communication with the one or more processors and adapted to communicate with an electronic communications network.

In some embodiments, the system also includes a third computer associated with a facility maintenance user (“a facility maintenance user computer”). It serves to provide access to interconnected facility equipment data for maintenance, repair, or operating status purposes through an electronic communications network. The facility maintenance user computer may have one or more processors, memory, and an input and output unit in communication with the one or more processors and adapted to communicate with the electronic communications network. The facility maintenance user computer also includes a maintenance user display and is positioned in communication with the operating status server.

The system in some embodiments also includes the non-transitory computer-readable memory of the equipment operating status server having computer program stored thereon. The computer program comprises a set of instructions that can be executed by the equipment operating status server and cause the equipment operating status server to perform various operations. When executed, the operations include first generating an interface on the display of the facility maintenance user computer. The interface includes a graphical user interface that is responsive to selection of one or more facility equipment operating status details by a facility maintenance user. The interface pictorially displays interconnected facility equipment data related to specific equipment details in specific facility locations in a manner readily navigable by a facility maintenance user in a direct, interrelated, non-sequential, and non-ordered arrangement of user selections (“a multidimensional lattice arrangement”).

The operations further include determining one or more interconnected facility equipment details responsive to the maintenance user selection of a facility equipment detail from the multidimensional lattice arrangement. The operations include retrieving the responsive details from the one or more interconnected facility equipment databases. When the facility maintenance user selects one or more specific pieces of equipment, the responsive details includes one or more of the following: equipment manufacturer information, graphical representation of equipment's appearance, room number of equipment's location, floor number of equipment's location, locations within a facility served by equipment, other equipment on which the one or more specific pieces of equipment depend to function properly, and other equipment which depends on the proper functioning of the one or more specific pieces of equipment. The responsive one or more interconnected facility equipment details when the facility maintenance user selects one or more specific pieces of equipment are a set of device properties.

Next, the operations include generating a display of the one or more interconnected facility equipment details responsive to the determined selection to be viewed through the graphical user interface (“a first interconnected facility equipment detail” and “a first location within the multidimensional lattice arrangement”).

The operations then include determining one or more interconnected facility equipment details responsive to a maintenance user selection of a facility equipment detail from the first interconnected facility equipment detail and the first location within the multidimensional lattice arrangement. The operations include retrieving responsive details from the one or more interconnected facility equipment databases. The responsive details include one or more of the set of device properties when the facility maintenance user selects one or more specific pieces of equipment.

Next, the operations include generating a display of the one or more interconnected facility equipment details responsive to the determined selection to be viewed through the graphical user interface (“a second interconnected facility equipment detail” and “a second location within the multidimensional lattice arrangement”). The second interconnected facility equipment detail and second location within the multidimensional lattice arrangement are different than the first interconnected facility equipment detail and first location.

Then, the operations include determining one or more interconnected facility equipment details responsive to the maintenance user selection from the second interconnected facility equipment detail and the second location within the multidimensional lattice arrangement. The operations further include retrieving responsive details from the one or more interconnected facility equipment databases. The responsive details include one or more of the set of device properties when the facility maintenance user selects one or more specific pieces of equipment.

The operations next include generating a display of the one or more interconnected facility equipment details responsive to the determined selection to be viewed through the graphical user interface (“a third interconnected facility equipment detail” and “a third location within the multidimensional lattice arrangement”). The third interconnected facility equipment detail and third location within the multidimensional lattice arrangement are different than each of the respective first interconnected facility equipment detail and first location and second interconnected equipment detail and second location.

These steps allow freedom of movement within the multidimensional lattice arrangement by the facility maintenance user computer to determine operating status and location of interconnected facility equipment.

Embodiments of the present invention also provide, for example, non-transitory computer-readable medium associated with an equipment operating status server having computer program stored thereon used to provide access to interconnected facility equipment data.

Embodiments of the present invention also provide, for example, a computer-implemented method of providing access to interconnected facility equipment data. The method includes generating, by a first computer associated with an equipment operating status data administrator (“an equipment operating status server”), an interface on the display of a second computer associated with a facility maintenance user (“a facility maintenance user computer”). The interface includes a graphical user interface that is responsive to selection of one or more facility equipment operating status details by a facility maintenance user. A facility maintenance user selection pictorially displays interconnected facility equipment data related to specific equipment details in specific facility locations. It displays the information in a manner readily navigable by a facility maintenance user in a direct, interrelated, non-sequential, and non-ordered arrangement of user selections: a multidimensional lattice arrangement.

The method also includes determining one or more interconnected facility equipment details responsive to the maintenance user selection of a facility equipment detail from the multidimensional lattice arrangement. The responsive details are retrieved from one or more interconnected facility equipment databases and include one or more of the following when the facility maintenance user selects one or more specific pieces of equipment: equipment manufacturer information, graphical representation of equipment's appearance, room number of equipment's location, floor number of equipment's location, locations within a facility served by equipment, other equipment on which the one or more specific pieces of equipment depends to function properly, and other equipment which depends on the proper functioning of the one or more specific pieces of equipment. The responsive one or more interconnected facility equipment details when the facility maintenance user selects one or more specific pieces of equipment are a set of device properties. The one or more interconnected facility equipment databases are positioned in communication with an electronic communications network and the equipment operating status server to store one or more interconnected facility equipment data files predetermined for a specific facility. The interconnected facility equipment data files are defined by facility location data files and facility equipment data files associated with equipment located within a facility to indicate operating status of the equipment. Operating status is separate from control of facility equipment in specific facility locations during operation. The interconnected facility equipment data files include one or more of the following: equipment manufacturer information, graphical representation of equipment's appearance, room number of equipment's location, floor number of equipment's location, locations within a facility served by equipment, other equipment on which equipment depends to function properly, and other equipment which depends on the proper functioning of equipment.

The method further includes generating a display of the one or more interconnected facility equipment details responsive to the determined selection to be viewed through the graphical user interface (“a first interconnected facility equipment detail” and “a first location within the multidimensional lattice arrangement”).

The method also includes determining one or more interconnected facility equipment details responsive to a maintenance user selection of a facility equipment detail from the first interconnected facility equipment detail and the first location within the multidimensional lattice arrangement. The responsive details are retrieved from the one or more interconnected facility equipment databases and include one or more of the set of device properties when the facility maintenance user selects one or more specific pieces of equipment.

The method additionally includes generating a display of the one or more interconnected facility equipment details responsive to the determined selection to be viewed through the graphical user interface (“a second interconnected facility equipment detail” and “a second location within the multidimensional lattice arrangement”). The second interconnected facility equipment detail and second location within the multidimensional lattice arrangement are different than the first interconnected facility equipment detail and first location.

The method further includes determining one or more interconnected facility equipment details responsive to the maintenance user selection from the second interconnected facility equipment detail and the second location within the multidimensional lattice arrangement. The responsive details are retrieved from the one or more interconnected facility equipment databases and include one or more of the set of device properties when the facility maintenance user selects one or more specific pieces of equipment.

The method also includes generating a display of the one or more interconnected facility equipment details responsive to the determined selection to be viewed through the graphical user interface (“a third interconnected facility equipment detail” and “a third location within the multidimensional lattice arrangement”). The third interconnected facility equipment detail and third location within the multidimensional lattice arrangement are different than each of the respective first interconnected facility equipment detail and first location and second interconnected equipment detail and second location.

Thus the method and other embodiments of the present invention—allow freedom of movement within the multidimensional lattice arrangement by the facility maintenance user to determine operating status and location of interconnected facility equipment. That freedom of movement is one of many advantages of the present invention. For example, the present invention advantageously eliminates the need to consult hard-copy references such as maintenance manuals and facility layout plans. Avoiding the need to consult hard-copy sources saves maintenance personnel time and reduces the time it takes for repairs or maintenance to be accomplished.

Furthermore, embodiments of the present invention allow maintenance personnel to access the interconnected facility equipment data from more than one location. When maintenance personnel can access the data through a web browser, for example, they do not need to be at the same location as the hard-copy references they would otherwise need to consult. Thus embodiments of the invention have significant advantages over using hard-copy references because maintenance personnel do not need to spend the enormous amount of time it would otherwise take to locate the information they need and, furthermore, they can access the data from many different locations without traveling to access hard-copy sources.

### BRIEF DESCRIPTION OF DRAWINGS

So that the manner in which the features and benefits of the invention, as well as others which will become apparent, may be understood in more detail, a more particular description of the invention briefly summarized above may be had by reference to the embodiments thereof which are illustrated in the appended drawings, which form a part of this specification. It is also to be noted, however, that the drawings illustrate only various embodiments of the invention and are therefore not to be considered limiting of the invention's scope as it may include other effective embodiments as well.

FIG. 1 is a schematic diagram of a system to provide access to interconnected facility equipment data according to an embodiment of the present invention;

FIG. 2 is a schematic diagram of a computer program stored on non-transitory computer-readable medium according to an embodiment of the present invention;

FIG. 3 is a schematic flow diagram of the flow of data in a system or method by which a facility maintenance user may access interconnected facility equipment data according to an embodiment of the present invention;

FIG. 4A is a schematic diagram illustrating the degrees of freedom in selection available to a facility maintenance user in an embodiment of the present invention;

FIG. 4B is a schematic diagram illustrating the degrees of freedom in selection available to a facility maintenance user under the prior art;

FIG. 5A is a schematic flow diagram of a method by which a facility maintenance user may access interconnected facility equipment data according to an embodiment of the present invention;

FIG. 5B is a continuation of the schematic flow diagram in FIG. 5A;

FIG. 6 is a schematic front view of an embodiment of a facility maintenance user computer interface of non-transitory computer-readable medium having computer program stored thereon and systems in the form of a graphical user interface of a display of a computer according to an embodiment of the present invention;

FIG. 7A represents the first of a sequence of displays of the graphical user interface in an embodiment of non-transitory computer-readable medium having computer program stored thereon and systems;

FIG. 7B represents the second in the sequence of displays beginning with FIG. 7A;

FIG. 7C represents the third in the sequence of displays beginning with FIG. 7A;

FIG. 7D represents the fourth in the sequence of displays beginning with FIG. 7A; and

FIG. 7E represents the fifth in the sequence of displays beginning with FIG. 7A.

### DETAILED DESCRIPTION

The present invention will now be described more fully hereinafter with reference to the accompanying drawings, which illustrate embodiments of the invention. This invention may, however, be embodied in many different forms and should not be construed as limited to the illustrated embodiments set forth herein; rather, these embodiments are provided so that this disclosure will be thorough and complete and will fully convey the scope of the invention to those skilled in the art. Like numbers refer to like elements throughout.

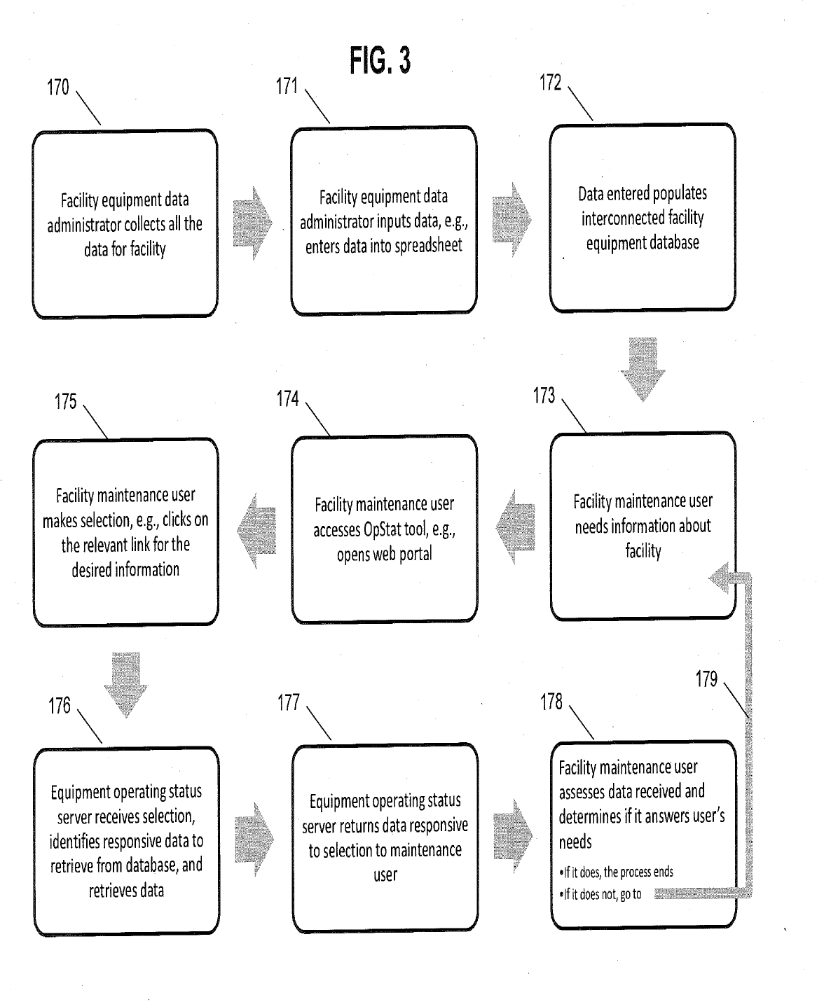

Embodiments of the present invention include a system or method by which a facility maintenance user may access interconnected facility equipment data. For example, FIG. 3 illustrates the flow of data in one embodiment. In this embodiment, the flow of data in the system or method includes a first step 170 in which the facility equipment data administrator collects all of the data for a facility. Next, in step 171, the facility equipment data administrator inputs data, for example, by entering the data into a spreadsheet. Then, in step 172, the entered data populates one or more interconnected facility equipment databases. In step 173, the facility maintenance user identifies a need for information about the facility. Then, in step 174, the facility maintenance user accesses the OpStat tool, one of the embodiments of the present invention. The facility maintenance user may do this through a web portal on the facility maintenance user computer. Next, in step 175, the facility maintenance user makes a selection, for example, by clicking on the relevant link for the desired information within the web portal. Then, in step 176, the equipment operating status server receives the facility maintenance user selection, identifies the data responsive to the selection, and retrieves it from the one or more interconnected facility equipment databases. Next, in step 177, the equipment operating status server returns the responsive data to the maintenance user computer. Then, in step 178, the facility maintenance user assesses the data received and determines whether it answers the identified need. If the data satisfies the need, the data flow ends. If it does not, the data flow process returns 179 to step 173.

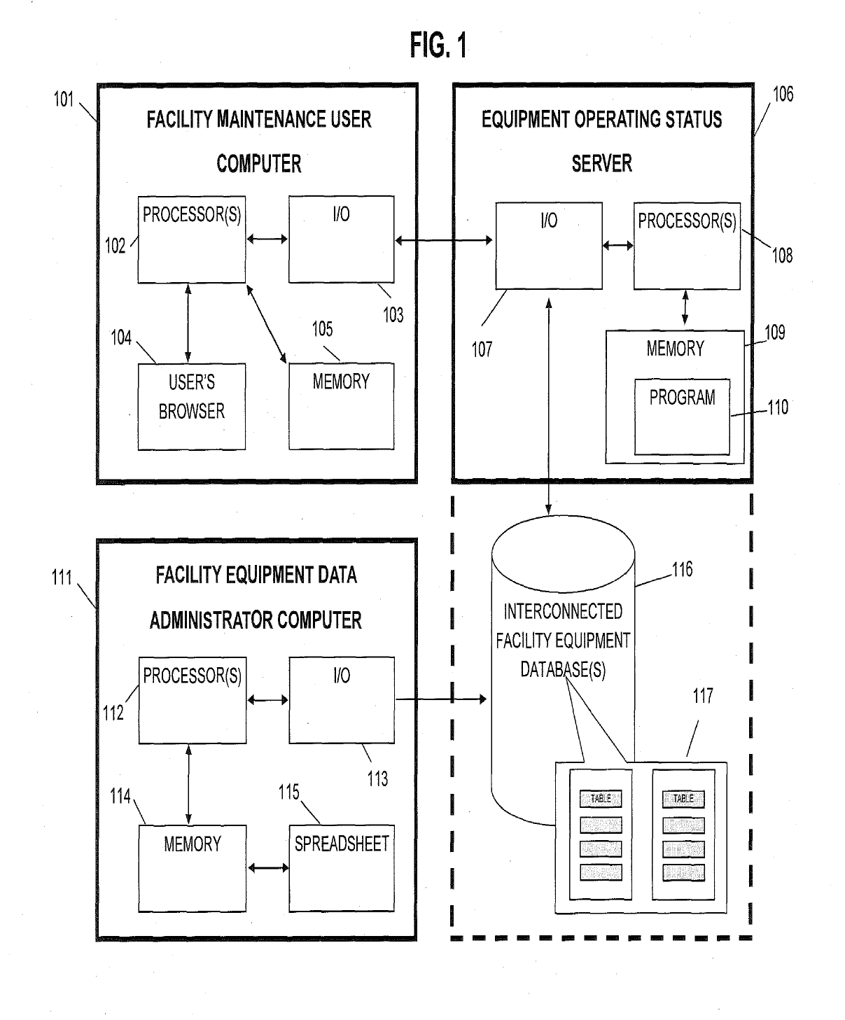

Embodiments of the present invention include a system to provide access to interconnected facility equipment data, as illustrated in FIG. 1. The system includes a first computer associated with an equipment operating status data administrator (“an equipment operating status server”) 106. The equipment operating status server 106 may have one or more processors 108, non-transitory computer-readable memory 109, and an input and output unit 107 in communication with the one or more processors 108 and adapted to communicate with an electronic communications network.

The system also includes one or more interconnected facility equipment databases 116. The databases are “interconnected” because the data files they store, one or more interconnected facility equipment data files 117, are interconnected with one another. That is, they include data indicating which pieces of data are related to one another and, if they are related, what the relationship is between them. The databases 116 are positioned in communication with an electronic communications network and the equipment operating status server 106 through its input and output unit 107. The databases 116 store one or more interconnected facility equipment data files 117 that have been predetermined for a specific facility. The interconnected facility equipment data files 117 are defined by facility location data files and facility equipment data files associated with equipment located within a facility to indicate operating status of the equipment. Operating status is separate from control of facility equipment in specific facility locations during operation and includes one or more of the following: equipment manufacturer information, graphical representation of equipment's appearance, room number of equipment's location, floor number of equipment's location, locations within a facility served by equipment, other equipment on which equipment depends to function properly, and other equipment which depends on the proper functioning of equipment.

The system in this embodiment also includes a second computer associated with a facility equipment data administrator (“a facility equipment data administrator computer”) 111. The facility data equipment administrator computer 111 serves to provide administrative access to facility equipment data. It also serves to provide facility equipment data to the one or more interconnected facility equipment databases 116 through its input and output unit 113. The facility equipment data administrator computer may have one or more processors 112, memory 114, and an input and output unit 113 in communication with the one or more processors and adapted to communicate with an electronic communications network. The facility data administrator may input facility equipment data through a spreadsheet 115 stored in memory 114 to populate the one or more interconnected facility equipment databases 116.

This embodiment of the system also includes a third computer associated with a facility maintenance user (“a facility maintenance user computer”) 101. It serves to provide access to interconnected facility equipment data for maintenance, repair, or operating status purposes through an electronic communications network. The facility maintenance user computer may have one or more processors 102, memory 105, and an input and output unit 103 in communication with the one or more processors and adapted to communicate with the electronic communications network. The facility maintenance user computer is positioned in communication with the operating status server 106 through its input and output unit 103. The facility maintenance user may access the interconnected facility equipment data through a web browser 104.

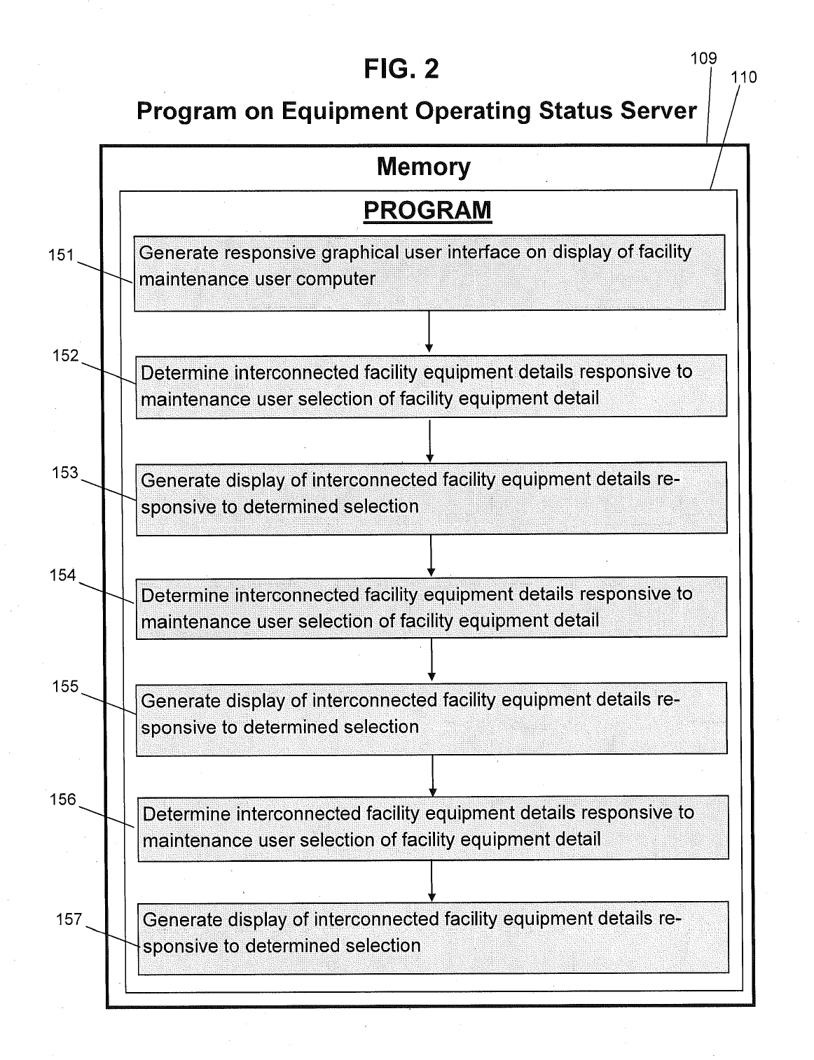

The system also includes computer program 110 stored on the non-transitory computer-readable memory 109 of the equipment operating status server 106. The computer program 110 comprises a set of instructions that can be executed by the equipment operating status server 106 and cause the equipment operating status server 106 to perform various operations. FIG. 2 illustrates one example the operations of this computer program. In the illustrated embodiment, the computer program 110 is stored on the non-transitory computer-readable memory 109 of the equipment operating status server 106. The program includes a first operation 151: generating responsive graphical user interface on the display of facility maintenance user computer 101 to serve as an initial display. The program next includes an operation 152: determining interconnected facility equipment details responsive to a maintenance user selection of one or more facility equipment details. The program further includes an operation 153: generating a display of the interconnected facility equipment details responsive to the determined selection of the facility maintenance user. The responsive details are a first interconnected facility equipment detail. The program also includes an operation 154: determining interconnected facility equipment details responsive to a maintenance user selection of one or more facility equipment details from the display resulting from operation 153, i.e., from the display of the first interconnected facility equipment detail. The program also includes an operation 155: generating a display of the interconnected facility equipment details responsive to the determined selection of the facility maintenance user. The responsive details are a second interconnected facility equipment detail. The program further includes an operation 156: determining interconnected facility equipment details responsive to a maintenance user selection of one or more facility equipment details from the display resulting from operation 155, i.e., from the display of the second interconnected facility equipment detail. The program also includes an operation 157: generating a display of the interconnected facility equipment details responsive to the determined selection of the facility maintenance user. The responsive details are a third interconnected facility equipment detail.

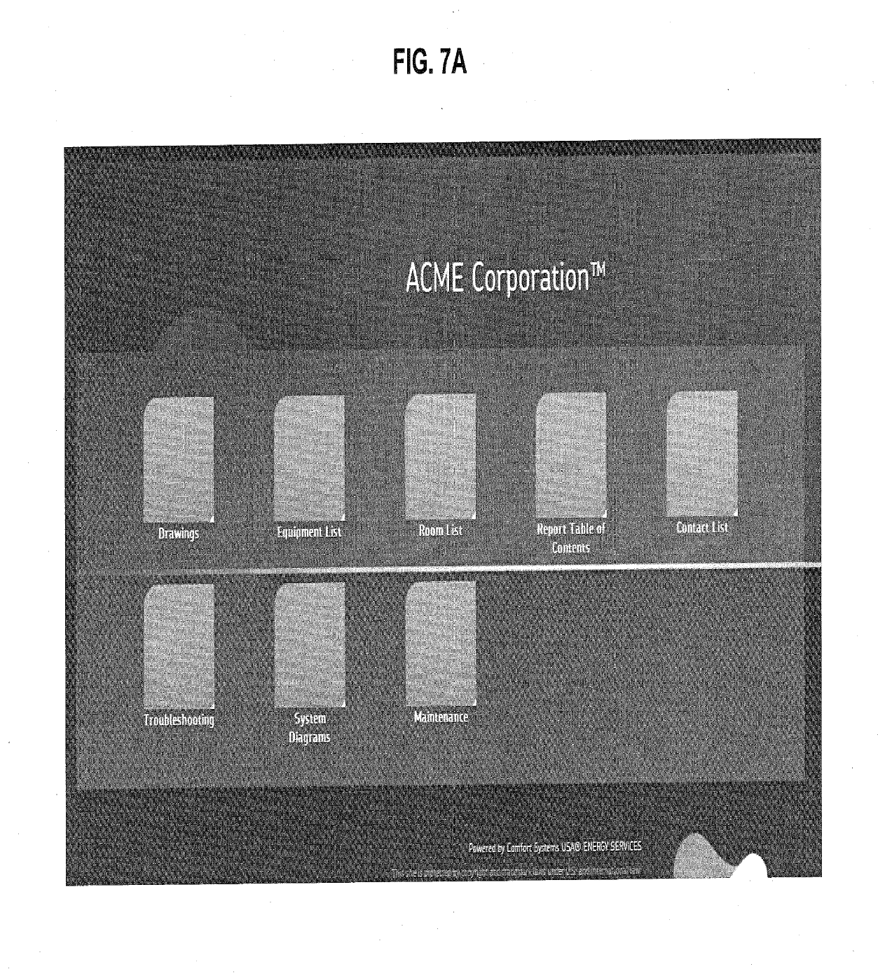

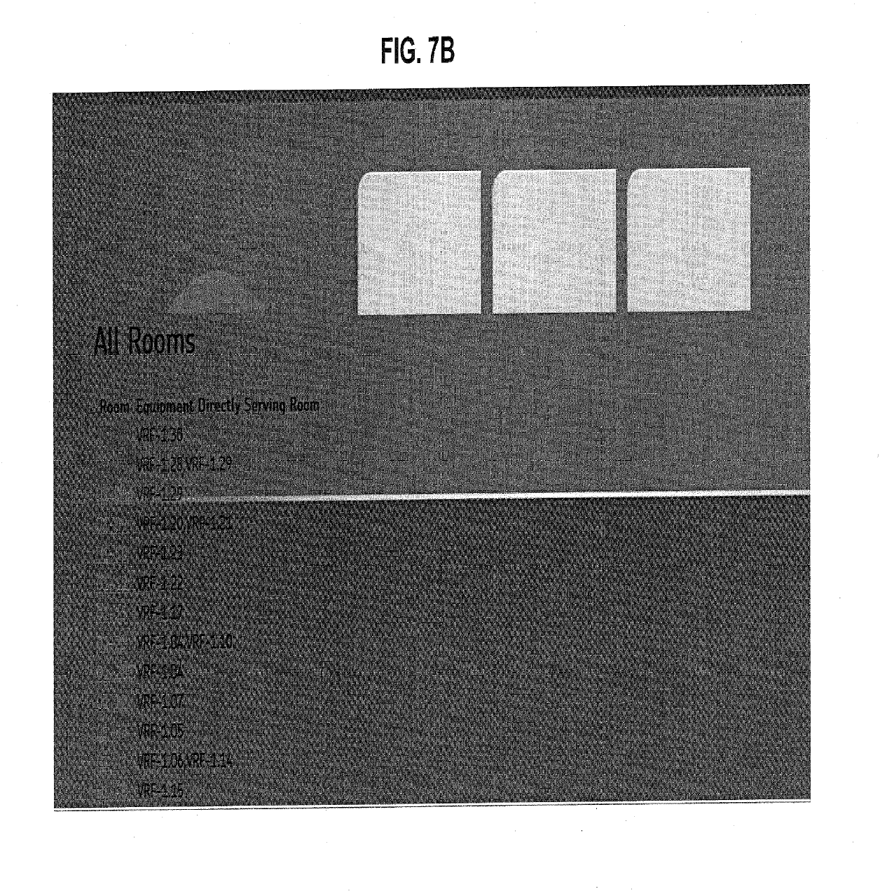

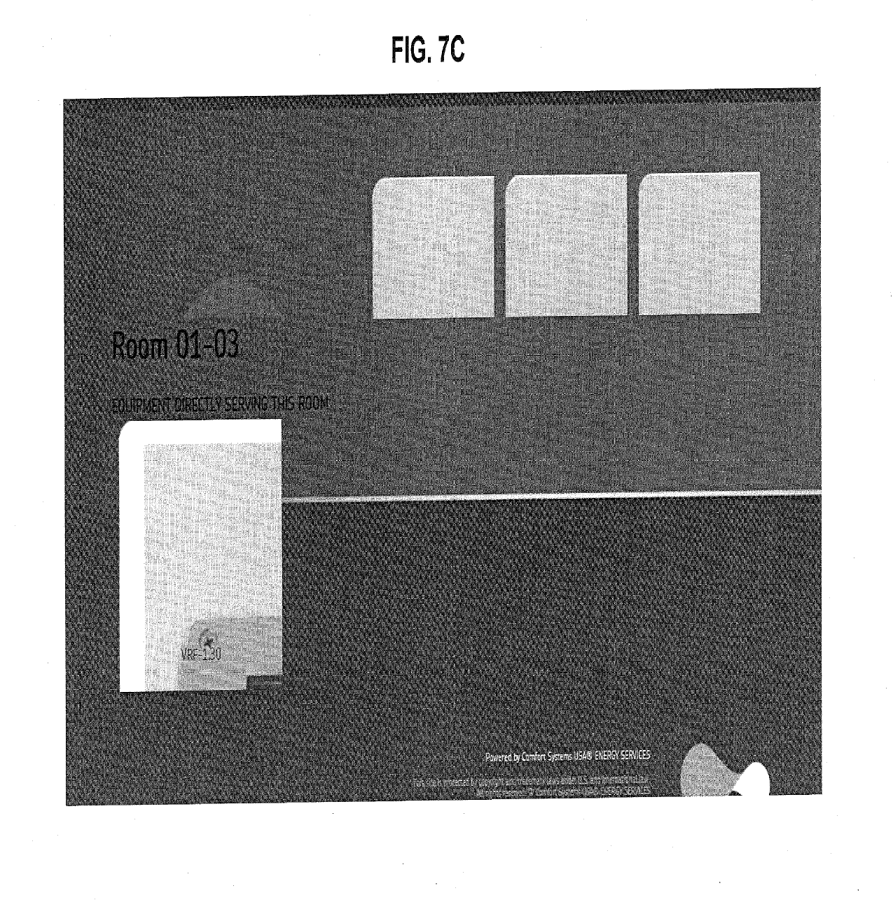

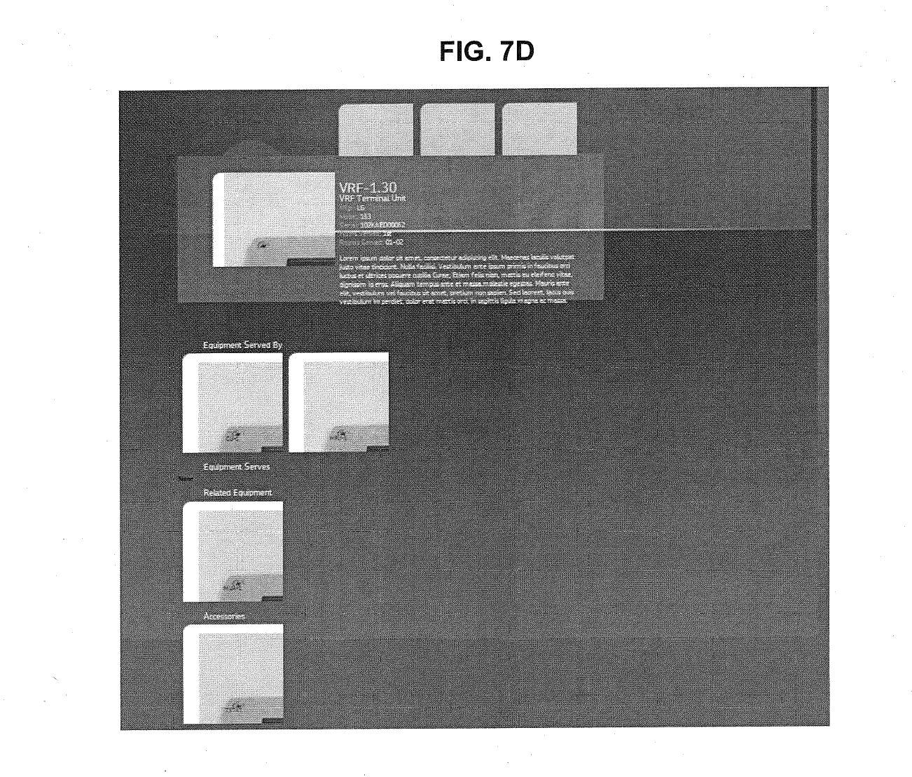

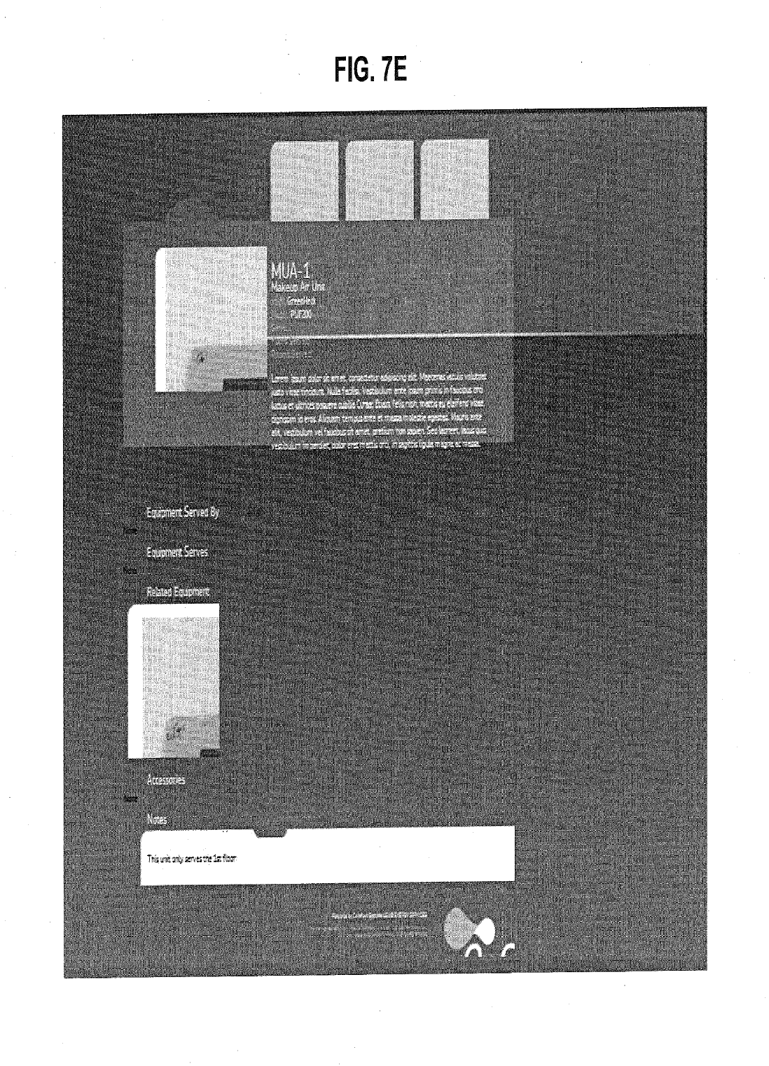

For example, FIGS. 7A, 7B, 7C, 7D, and 7E depict the graphical user interface a facility maintenance user might see when using the system in this embodiment. FIG. 7A shows the graphical user interface that the user would see when the tool is first accessed. That is, FIG. 7A shows the graphical user interface that results from operation 151: the initial display. In this sequence, the user selects “Room List” by clicking on the text of the words. After the user selects “Room List,” the next operation 152 occurs: determining interconnected facility equipment details responsive to the selection. In this case, the responsive details are the rooms located within the building to which this set of interconnected facility equipment data files 117 corresponds. As a result, the next operation 153 causes the graphical user interface to display the responsive list of rooms, as illustrated in FIG. 7B. This list is the first interconnected facility equipment detail.

From the display of the first interconnected facility equipment detail, which is the list of rooms in FIG. 7B, the user may select an individual room. In the sequence of FIGS. 7A, 7B, 7C, 7D, and 7E, the user selects the first room listed, 01-03, by clicking on its name. The user's selection causes the computer to perform operation 154: determine the interconnected facility equipment details responsive to the user selection of room 01-03. In this case, the responsive details are the equipment directly serving room 01-03. After performing operation 154, the next operation 155 causes the computer to generate a display of the responsive details, i.e., the equipment directly serving the room, through the graphical user interface, as depicted in FIG. 7C. In this case, only one piece of equipment is serving room 01-03: variable refrigerant flow (VRF) unit 1.30. This piece of equipment, which is the responsive detail of operation 155, is the second interconnected facility equipment detail.

From the display of the second interconnected facility equipment detail, which is the equipment serving room 01-03 in FIG. 7C, the user may select an individual piece of equipment. In the sequence of FIGS. 7A, 7B, 7C, 7D, and 7E, the user selects the only piece of equipment: VRF 1.30. The user selection causes the computer to perform operation 156: to determine the interconnected facility equipment details responsive to the user selection of VRF 1.30. Here, the responsive details are the details about that piece of equipment, including equipment manufacturer information, a photograph of the equipment, room number of equipment's location, floor number of equipment's location, locations within the facility served by equipment, other equipment on which the equipment depends to function properly, and other equipment which depends on the proper functioning of equipment. After performing operation 156, the next operation 157 causes the computer to generate a display of the responsive details, i.e., the details about VRF 1.30, as depicted in FIG. 7D. These details about VRF 1.30, which are the responsive details of operations 156 and 157, are the third interconnected facility equipment detail.

The user may continue to make selections in a similar manner until he or she has found all of the information needed to complete a task. For example, from the graphical user interface's display of the details about VRF 1.30, as depicted in FIG. 7D, the user can find out more information about equipment related to VRF 1.30 by selecting a piece of equipment listed under the “Related Equipment” heading. Here, only one piece of related equipment exists: MUA 1. If the user selects MUA 1 by clicking on its name, the graphical user interface displays details about MUA 1, like those displayed for VRF 1.30, as depicted in FIG. 7E. The process of user selections can continue in a similar manner.

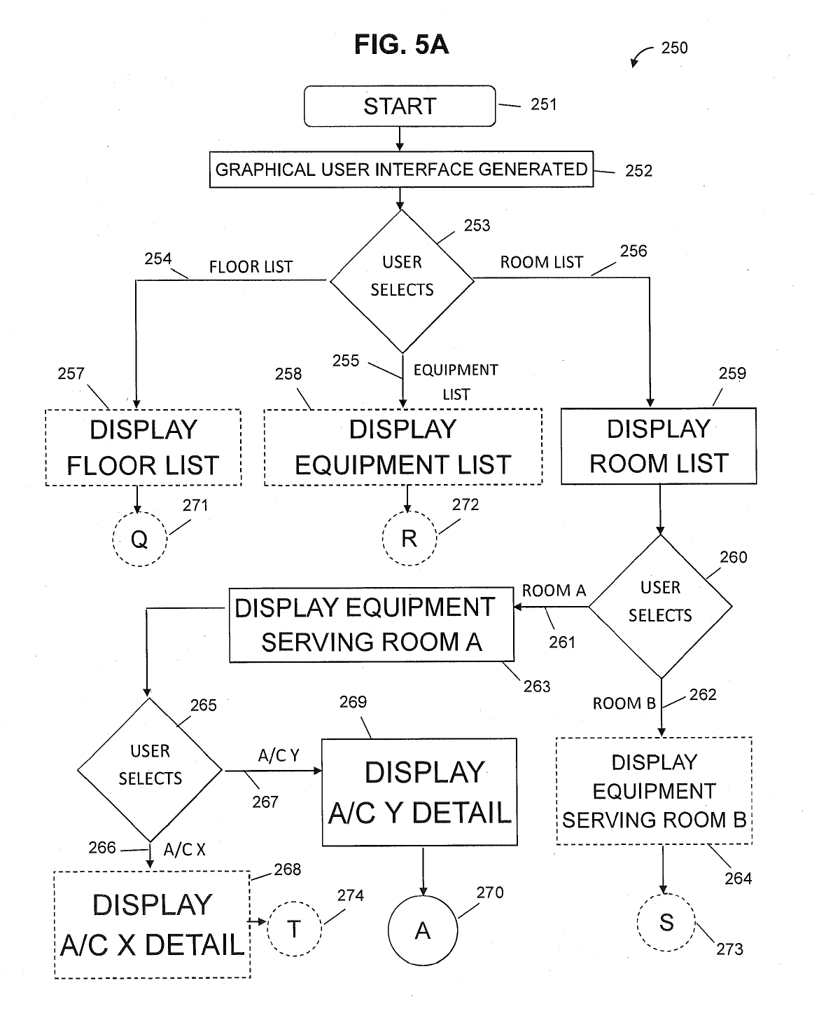

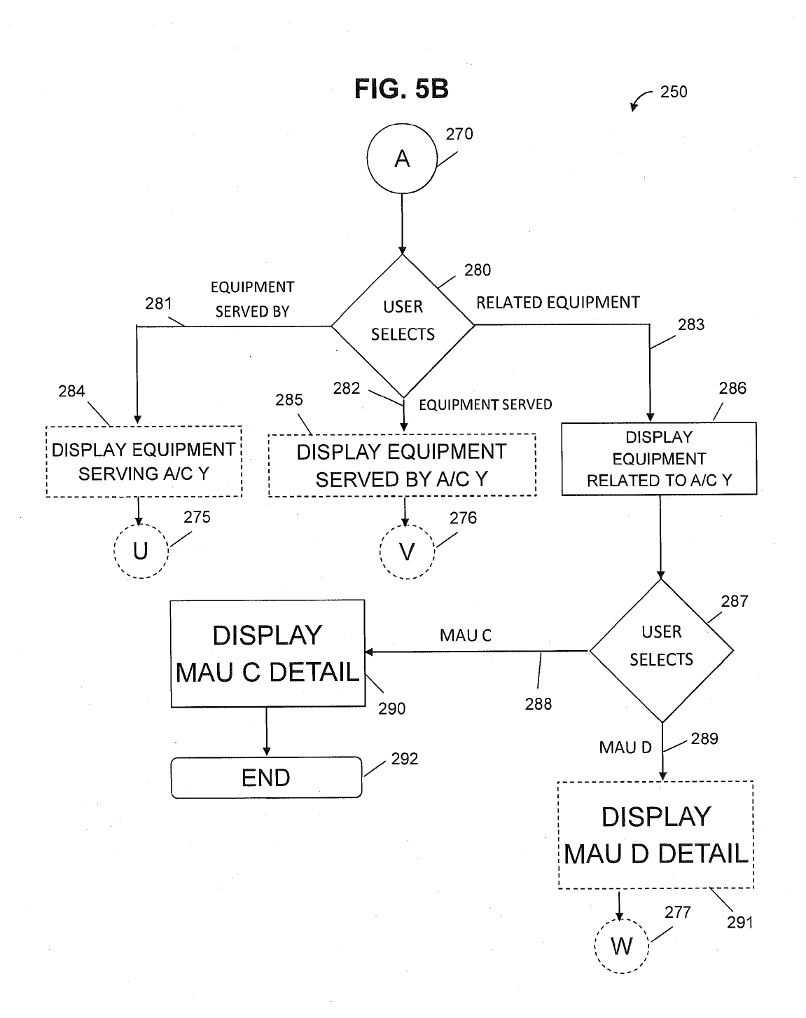

The decision flow diagram 250 in FIGS. 5A and 5B also illustrates an example of a facility maintenance user's path of selections of interconnected facility equipment data. After the start 251, the graphical user interface is generated 252 and displays a range of options for the user. The user selects the floor list 254, selects the equipment list 255, or selects the room list 256. Here, the user selects the room list 256. However, if the user had selected the floor list 254, the interface would have displayed the floor list 257 as a result. In addition, the user would have been able to make other selections 271 from the floor list display 257. Likewise, if the user had selected the equipment list 255, the graphical user interface would have displayed the equipment list 258. Further, the user would have been able to make other selections 272 from the displayed equipment list 258. Because the user selects the room list 256, the graphical user interface displays the room list 259, i.e., a list of the rooms within a facility. Next, the user either selects room A 261 or selects room B 262. Here, the user selects room A 261. However, if the user had selected room B 262, the graphical user interface would have displayed the equipment serving room B 264. Additionally, the user would have been able to make other selections 273 from the display of equipment serving room B 264. Because the user selects room A 261, the graphical user interface displays equipment serving room A 263. Next, the user selects either air conditioning unit X 266 or selects air conditioning unit Y 267. Here, the user selects air conditioning unit Y 267. If the user had selected air conditioning unit X 266, the graphical user interface would have displayed the details of air conditioning unit X 268. Furthermore, the user would have been able to make other selections 274 from the display of the details of air conditioning unit X 268. Because the user selects air conditioning unit Y 267, the graphical user interface displays the details of air conditioning unit Y 269.

The decision flow diagram 250 continues 270 in FIG. 5B. Next, the user selects the equipment serving air conditioning unit Y 281, selects the equipment served by air conditioning unit Y 282, or selects the equipment related to air conditioning unit Y 283. Here, the user selects the equipment related to air conditioning unit Y 283. However, if the user had selected the equipment serving air conditioning unit Y 281, the interface would have displayed the equipment serving air conditioning unit Y 284 as a result. In addition, the user would have been able to make other selections 275 from the equipment serving air conditioning unit Y display 284. Likewise, if the user had selected the equipment served by air conditioning unit Y 282, the graphical user interface would have displayed the equipment served by air conditioning unit Y 285. Further, the user would have been able to make other selections 276 from the displayed equipment served by air conditioning unit Y 285. Because the user selects the equipment related to air conditioning unit Y 283, the graphical user interface displays the equipment related to air conditioning unit Y 286. Next, the user either selects makeup air unit (MAU) C 288 or selects MAU D 289. Here, the user selects MAU C 288. However, if the user had selected MAU D 289, the graphical user interface would have displayed the details of MAU D 291. Additionally, the user would have been able to make other selections 277 from the display of the details of MAU D 291. Because the user selects MAU C 288, the graphical user interface displays the details of MAU C 290. In this example, the details of MUA C answer the user's needs, and the decision process ends 292.

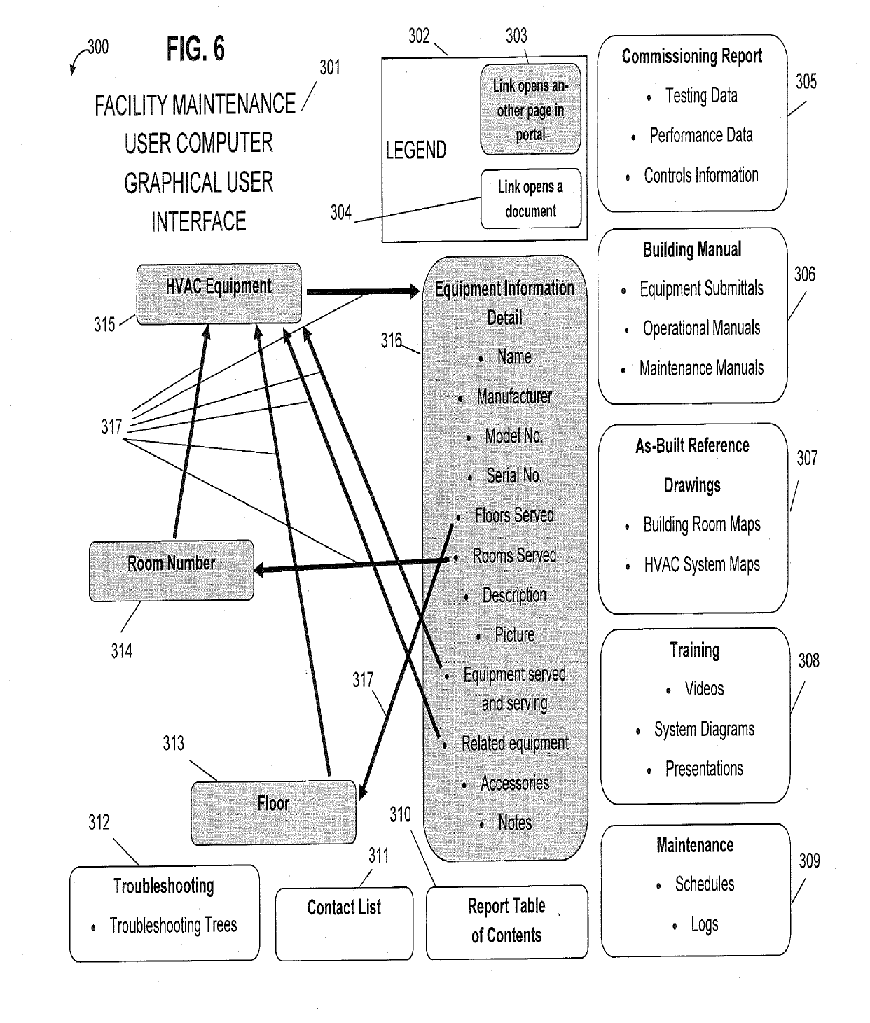

The user's experience with the graphical user interface is illustrated by FIG. 6. Depiction 300 is an example of a schematic front view of a user's selection choices within the graphical user interface of a computer display. In this example, the interface is organized into several modules 305-316. The facility maintenance user computer graphical user interface 301 provides the user with several potential selections from which to choose in this example: a commissioning report module 305, a building manual module 306, an as-built reference drawings module 307, a training module 308, a maintenance module 309, a report table of contents module 310, a contact list module 311, a troubleshooting module 312, a floor module 313, a room number module 314, a HVAC equipment module 315, and an equipment information detail module 316. As explained by the legend 302, the modules characterized by shading 303 cause the graphical user interface 301 to display another module when selected, whereas the modules without shading 304 cause the graphical user interface to open a document outside of the interface 301. Among the modules characterized by shading 303 which cause the graphical user interface 301 to display another module when selected, arrows 317 indicate the display that results when a link within a module is selected. For example, if a user clicks on a specific floor link within the floor module 313, the graphical user interface 301 displays the list of HVAC equipment serving that floor or located on that floor. If the user then selects a specific equipment link within the HVAC equipment module 315, the graphical user interface 301 displays the equipment information detail 316 for the equipment. If the user then selects a related equipment link within the equipment information detail module, the graphical user interface 301 displays a list of related equipment in the HVAC equipment module 315.

An embodiment of the present invention may include, for example, an initial display of the graphical user interface, as illustrated in FIG. 7A.

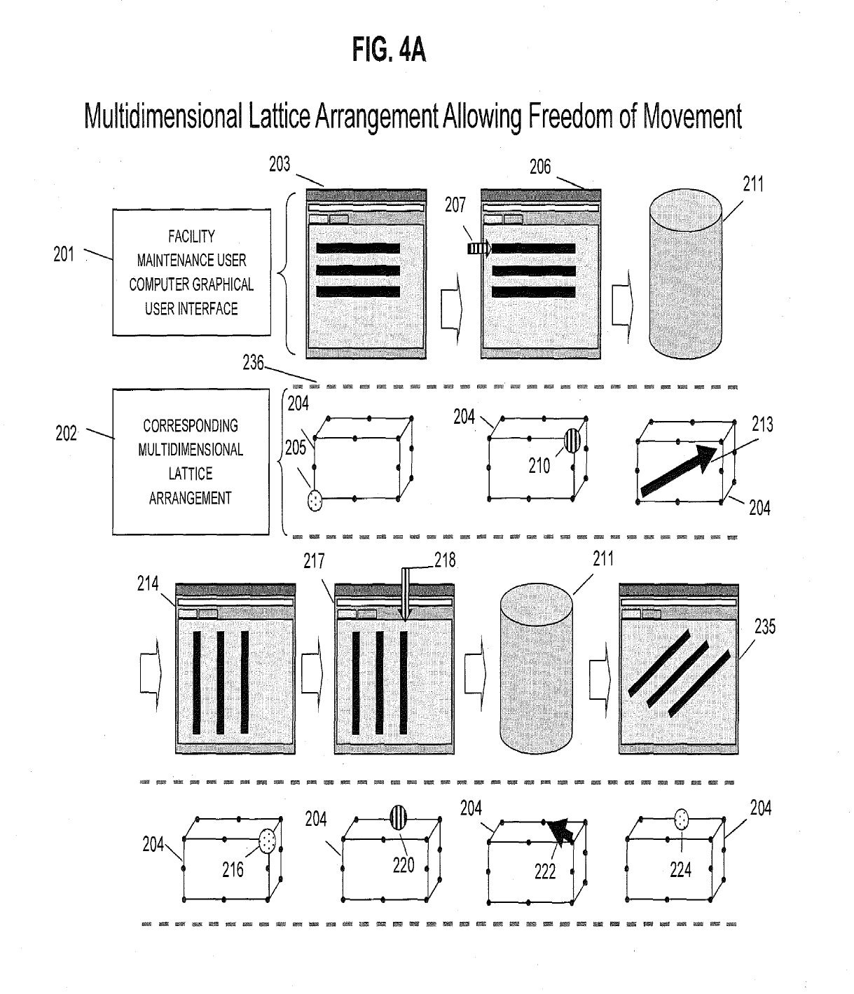

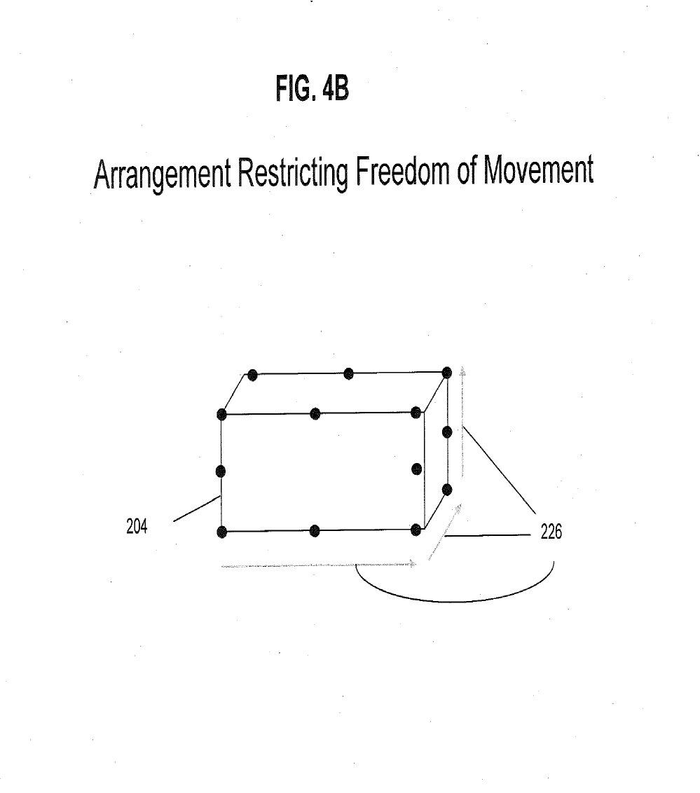

One of the advantages of embodiments of the present invention is that they increase the degrees of freedom in selection available to a facility maintenance user in an embodiment of the present invention from the degrees of freedom in selection available to a facility maintenance user under the prior art. This increase in the degrees of freedom is illustrated by FIGS. 4A and 4B. FIG. 4A describes features of the present invention, whereas FIG. 4B describes features of the prior art. The multidimensional lattice arrangement allowing freedom of movement is a feature of the present invention, whereas the arrangement restricting freedom of movement characterizes the prior art. The lattice framework 204 represents the relationships between interconnected facility equipment data. Under the prior art, the limited freedom of user choice can be thought of as restricting movement from one point to another solely along the edges of the lattice. Conversely, the present invention can be thought of as permitting movement from one point to another through paths not restricted to the edges of the lattice. In FIG. 4A, the depictions outside the bounds of the dotted lines 236 represent views of the facility maintenance user computer graphical user interface 201. The depictions within the dotted lines 236 represent the corresponding multidimensional lattice arrangement, so as to illustrate the degrees of freedom in selection available to a facility maintenance user. The display 203 is the graphical user interface display before the user makes a selection. The lattice framework 204 represents the relationships between interconnected facility equipment data. Point 205 is a representation of the data currently displayed when the graphical user interface displays display 203. Display 206 is the graphical user interface display as the user makes a selection of an interconnected facility equipment detail, where pointer 207 indicates the user selection. Point 210 is the corresponding representation of the data responsive to the user selection indicated by pointer 207. One or more interconnected facility equipment databases 211 are accessed to retrieve the responsive details, and pointer 203 represents the relationship between and movement from point 205 to point 210. Pointer 213 is a representation of the path taken directly as the display changes to respond to the user selection. Display 214 is the graphical user interface display reflecting the details responsive to the user selection indicated by pointer 207. Point 216 is a representation of the data currently displayed when the graphical user interface displays display 214. Display 217 is the graphical user interface display as the user makes a selection of an interconnected facility equipment detail, where pointer 218 indicates the user selection. Point 220 is the corresponding representation of the data responsive to the user selection indicated by pointer 218. Pointer 222 is a representation of the path taken directly as the display changes to respond to the user selection. Display 235 is the graphical user interface display reflecting the details responsive to the user selection indicated by pointer 218. Point 205 is a representation of the data currently displayed when the graphical user interface displays display 235.

This application is a non-provisional of and claims the benefit and priority to U.S. Provisional Patent Application No. 61/678,029 titled “System, Method, and Computer Medium Having Computer Program Stored Thereon to Provide User Access to Consolidated, Interconnected Facility Equipment Information and Operating Status” filed Jul. 31, 2012, which is incorporated herein by reference in its entirety.

Many modifications and other embodiments of the invention will come to the mind of those skilled in the art having the benefit of the teachings presented in the foregoing descriptions and the associated drawings. Therefore, it is to be understood that the invention is not to be limited to the illustrated embodiments disclosed, and that modifications and other embodiments are intended to be included within the scope of the appended claims.

That claimed is:

1. A system to provide access to interconnected facility equipment data, the system comprising:
a first computer associated with an equipment operating status data administrator and defining an equipment operating status server, the equipment operating status server having one or more processors, non-transitory computer-readable memory, and an input and output unit in communication with the one or more processors and adapted to communicate with an electronic communications network;
one or more interconnected facility equipment databases positioned in communication with an electronic communications network and the equipment operating status server to store one or more interconnected facility equipment data files predetermined for a specific facility, the interconnected facility equipment data files being defined by facility location data files and facility equipment data files associated with equipment located within a facility to indicate operating status of the equipment separate from control of facility equipment in specific facility locations during operation and including one or more of the following: equipment manufacturer information, graphical representation of equipment's appearance, room number of equipment's location, floor number of equipment's location, locations within a facility served by equipment, other equipment on which equipment depends to function properly, and other equipment which depends on the proper functioning of equipment;
a second computer associated with a facility equipment data administrator defining a facility equipment data administrator computer to provide administrative access to facility equipment data and provide facility equipment data to the one or more interconnected facility equipment databases, the facility equipment data administrator computer having one or more processors, memory, and an input and output unit in communication with the one or more processors and adapted to communicate with an electronic communications network;
a third computer associated with a facility maintenance user to provide access to interconnected facility equipment data for maintenance, repair, or operating status purposes through an electronic communications network and defining a facility maintenance user computer, the facility maintenance user computer having one or more processors, memory, and an input and output unit in communication with the one or more processors, and a maintenance user display and adapted to communicate with the electronic communications network, and positioned in communication with the operating status server; and
computer program stored on the non-transitory computer-readable memory of the equipment operating status server, the computer program comprising a set of instructions that, when executed by the operating status server, cause the operating status server to perform the operations of:
generating an interface on the display of the facility maintenance user computer, the interface including a graphical user interface being responsive to selection of one or more facility equipment operating status details by a facility maintenance user thereby to pictorially display interconnected facility equipment data related to specific equipment details in specific facility locations in a manner readily navigable by a facility maintenance user in a direct, interrelated, non-sequential, and non-ordered arrangement of user selections so as to define a multidimensional lattice arrangement;
determining one or more interconnected facility equipment details responsive to the maintenance user selection of a facility equipment detail from the multidimensional lattice arrangement to thereby retrieve the responsive details from the one or more interconnected facility equipment databases, the responsive details including one or more of the following when the facility maintenance user selects one or more specific pieces of equipment: equipment manufacturer information, graphical representation of equipment's appearance, room number of equipment's location, floor number of equipment's location, locations within a facility served by equipment, other equipment on which the one or more specific pieces of equipment depends to function properly, and other equipment which depends on the proper functioning of the one or more specific pieces of equipment, the responsive one or more interconnected facility equipment details when the facility maintenance user selects one or more specific pieces of equipment thereby defining a set of device properties;
generating a display of the one or more interconnected facility equipment details responsive to the determined selection to be viewed through the graphical user interface and to define a first interconnected facility equipment detail and a first location within the multidimensional lattice arrangement;
determining one or more interconnected facility equipment details responsive to a maintenance user selection of a facility equipment detail from the first interconnected facility equipment detail and the first location within the multidimensional lattice arrangement to thereby retrieve responsive details from the one or more interconnected facility equipment databases, the responsive details including one or more of the set of device properties when the facility maintenance user selects one or more specific pieces of equipment;
generating a display of the one or more interconnected facility equipment details responsive to the determined selection to be viewed through the graphical user interface and to define a second interconnected facility equipment detail and a second location within the multidimensional lattice arrangement, the second interconnected facility equipment detail and second location within the multidimensional lattice arrangement being different than the first interconnected facility equipment detail and first location;
determining one or more interconnected facility equipment details responsive to the maintenance user selection from the second interconnected facility equipment detail and the second location within the multidimensional lattice arrangement to thereby retrieve responsive details from the one or more interconnected facility equipment databases, the responsive details including one or more of the set of device properties when the facility maintenance user selects one or more specific pieces of equipment; and
generating a display of the one or more interconnected facility equipment details responsive to the determined selection to be viewed through the graphical user interface and to define a third interconnected facility equipment detail and a third location within the multidimensional lattice arrangement, the third interconnected facility equipment detail and third location within the multidimensional lattice arrangement being different than each of the respective first interconnected facility equipment detail and first location and second interconnected equipment detail and second location to thereby allow freedom of movement within the multidimensional lattice arrangement by the maintenance computer user to determine operating status and location of interconnected facility equipment.

2. A system as defined in claim 1, wherein each of one or more specific pieces of equipment has an identity associated with the same manufacturer or a family of the same manufacturer.

3. A system as defined in claim 1, wherein the set of device properties includes a photographic image of the one or more specific pieces of equipment.

4. A system as defined in claim 1, wherein the set of device properties includes a photograph of the one or more specific pieces of equipment as installed in the facility.

5. A system as defined in claim 1, wherein the set of device properties includes a schematic diagram of the one or more specific pieces of equipment.

6. A system as defined in claim 1, wherein the set of device properties includes a link to a troubleshooting decision tree arrangement for the one or more specific pieces of equipment.

7. A system as defined in claim 1, wherein the graphical user interface displays the one or more facility equipment operating status details in a manner representing hard-copy pages of a user manual.

8. A computer-implemented method of providing access to interconnected facility equipment data, the computer-implemented method comprising:
generating, by a first computer associated with an equipment operating status data administrator and defining an equipment operating status server, an interface on the display of a second computer associated with a facility maintenance user and defining a facility maintenance user computer, the interface including a graphical user interface being responsive to selection of one or more facility equipment operating status details by a facility maintenance user thereby to pictorially display interconnected facility equipment data related to specific equipment details in specific facility locations in a manner readily navigable by a facility maintenance user in a direct, interrelated, non-sequential, and non-ordered arrangement of user selections so as to define a multidimensional lattice arrangement;
determining one or more interconnected facility equipment details responsive to the maintenance user selection of a facility equipment detail from the multidimensional lattice arrangement to thereby retrieve the responsive details from one or more interconnected facility equipment databases, the responsive details including one or more of the following when the facility maintenance user selects one or more specific pieces of equipment: equipment manufacturer information, graphical representation of equipment's appearance, room number of equipment's location, floor number of equipment's location, locations within a facility served by equipment, other equipment on which the one or more specific pieces of equipment depends to function properly, and other equipment which depends on the proper functioning of the one or more specific pieces of equipment, the responsive one or more interconnected facility equipment details when the facility maintenance user selects one or more specific pieces of equipment thereby defining a set of device properties, wherein the one or more interconnected facility equipment databases are positioned in communication with an electronic communications network and the equipment operating status server to store one or more interconnected facility equipment data files predetermined for a specific facility, the interconnected facility equipment data files being defined by facility location data files and facility equipment data files associated with equipment located within a facility to indicate operating status of the equipment separate from control of facility equipment in specific facility locations during operation and including one or more of the following: equipment manufacturer information, graphical representation of equipment's appearance, room number of equipment's location, floor number of equipment's location, locations within a facility served by equipment, other equipment on which equipment depends to function properly, and other equipment which depends on the proper functioning of equipment;
generating a display of the one or more interconnected facility equipment details responsive to the determined selection to be viewed through the graphical user interface and to define a first interconnected facility equipment detail and a first location within the multidimensional lattice arrangement;
determining one or more interconnected facility equipment details responsive to a maintenance user selection of a facility equipment detail from the first interconnected facility equipment detail and the first location within the multidimensional lattice arrangement to thereby retrieve responsive details from the one or more interconnected facility equipment databases, the responsive details including one or more of the set of device properties when the facility maintenance user selects one or more specific pieces of equipment;
generating a display of the one or more interconnected facility equipment details responsive to the determined selection to be viewed through the graphical user interface and to define a second interconnected facility equipment detail and a second location within the multidimensional lattice arrangement, the second interconnected facility equipment detail and second location within the multidimensional lattice arrangement being different than the first interconnected facility equipment detail and first location;
determining one or more interconnected facility equipment details responsive to the maintenance user selection from the second interconnected facility equipment detail and the second location within the multidimensional lattice arrangement to thereby retrieve responsive details from the one or more interconnected facility equipment databases, the responsive details including one or more of the set of device properties when the facility maintenance user selects one or more specific pieces of equipment; and
generating a display of the one or more interconnected facility equipment details responsive to the determined selection to be viewed through the graphical user interface and to define a third interconnected facility equipment detail and a third location within the multidimensional lattice arrangement, the third interconnected facility equipment detail and third location within the multidimensional lattice arrangement being different than each of the respective first interconnected facility equipment detail and first location and second interconnected equipment detail and second location to thereby allow freedom of movement within the multidimensional lattice arrangement by the maintenance computer user to determine operating status and location of interconnected facility equipment.

9. A computer-implemented method as defined in claim 8, wherein each of one or more specific pieces of equipment has an identity associated with the same manufacturer or a family of the same manufacturer.

10. A computer-implemented method as defined in claim 8, wherein the set of device properties includes a photographic image of the one or more specific pieces of equipment.

11. A computer-implemented method as defined in claim 8, wherein the set of device properties includes a photograph of the one or more specific pieces of equipment as installed in the facility.

12. A computer-implemented method as defined in claim 8, wherein the set of device properties includes a schematic diagram of the one or more specific pieces of equipment.

13. A computer-implemented method as defined in claim 8, wherein the set of device properties includes a link to a troubleshooting decision tree arrangement for the one or more specific pieces of equipment.

14. A computer-implemented method as defined in claim 8, wherein the graphical user interface displays the one or more facility equipment operating status details in a manner representing hard-copy pages of a user manual.

15. Non-transitory computer-readable medium having computer program stored thereon, used to provide access to interconnected facility equipment data, the computer program comprising a set of instructions that, when executed by the computer, cause the computer to perform the operations of:
generating, by a first computer associated with an equipment operating status data administrator and defining an equipment operating status server, an interface on the display of a second computer associated with a facility maintenance user and defining a facility maintenance user computer, the interface including a graphical user interface being responsive to selection of one or more facility equipment operating status details by a facility maintenance user thereby to pictorially display interconnected facility equipment data related to specific equipment details in specific facility locations in a manner readily navigable by a facility maintenance user in a direct, interrelated, non-sequential, and non-ordered arrangement of user selections so as to define a multidimensional lattice arrangement;
determining one or more interconnected facility equipment details responsive to the maintenance user selection of a facility equipment detail from the multidimensional lattice arrangement to thereby retrieve the responsive details from one or more interconnected facility equipment databases, the responsive details including one or more of the following when the facility maintenance user selects one or more specific pieces of equipment: equipment manufacturer information, graphical representation of equipment's appearance, room number of equipment's location, floor number of equipment's location, locations within a facility served by equipment, other equipment on which the one or more specific pieces of equipment depends to function properly, and other equipment which depends on the proper functioning of the one or more specific pieces of equipment, the responsive one or more interconnected facility equipment details when the facility maintenance user selects one or more specific pieces of equipment thereby defining a set of device properties, wherein the one or more interconnected facility equipment databases are positioned in communication with an electronic communications network and the equipment operating status server to store one or more interconnected facility equipment data files predetermined for a specific facility, the interconnected facility equipment data files being defined by facility location data files and facility equipment data files associated with equipment located within a facility to indicate operating status of the equipment separate from control of facility equipment in specific facility locations during operation and including one or more of the following: equipment manufacturer information, graphical representation of equipment's appearance, room number of equipment's location, floor number of equipment's location, locations within a facility served by equipment, other equipment on which equipment depends to function properly, and other equipment which depends on the proper functioning of equipment;
generating a display of the one or more interconnected facility equipment details responsive to the determined selection to be viewed through the graphical user interface and to define a first interconnected facility equipment detail and a first location within the multidimensional lattice arrangement;
determining one or more interconnected facility equipment details responsive to a maintenance user selection of a facility equipment detail from the first interconnected facility equipment detail and the first location within the multidimensional lattice arrangement to thereby retrieve responsive details from the one or more interconnected facility equipment databases, the responsive details including one or more of the set of device properties when the facility maintenance user selects one or more specific pieces of equipment;
generating a display of the one or more interconnected facility equipment details responsive to the determined selection to be viewed through the graphical user interface and to define a second interconnected facility equipment detail and a second location within the multidimensional lattice arrangement, the second interconnected facility equipment detail and second location within the multidimensional lattice arrangement being different than the first interconnected facility equipment detail and first location;
determining one or more interconnected facility equipment details responsive to the maintenance user selection from the second interconnected facility equipment detail and the second location within the multidimensional lattice arrangement to thereby retrieve responsive details from the one or more interconnected facility equipment databases, the responsive details including one or more of the set of device properties when the facility maintenance user selects one or more specific pieces of equipment; and
generating a display of the one or more interconnected facility equipment details responsive to the determined selection to be viewed through the graphical user interface and to define a third interconnected facility equipment detail and a third location within the multidimensional lattice arrangement, the third interconnected facility equipment detail and third location within the multidimensional lattice arrangement being different than each of the respective first interconnected facility equipment detail and first location and second interconnected equipment detail and second location to thereby allow freedom of movement within the multidimensional lattice arrangement by the maintenance computer user to determine operating status and location of interconnected facility equipment.

16. Non-transitory computer-readable medium having computer program stored thereon as defined in claim 15, wherein each of one or more specific pieces of equipment has an identity associated with the same manufacturer or a family of the same manufacturer.

17. Non-transitory computer-readable medium having computer program stored thereon as defined in claim 15, wherein the set of device properties includes a photographic image of the one or more specific pieces of equipment.

18. Non-transitory computer-readable medium having computer program stored thereon as defined in claim 15, wherein the set of device properties includes a photograph of the one or more specific pieces of equipment as installed in the facility.

19. Non-transitory computer-readable medium having computer program stored thereon as defined in claim 15, wherein the set of device properties includes a schematic diagram of the one or more specific pieces of equipment.

20. Non-transitory computer-readable medium having computer program stored thereon as defined in claim 15, wherein the set of device properties includes a link to a troubleshooting decision tree arrangement for the one or more specific pieces of equipment.

21. Non-transitory computer-readable medium having computer program stored thereon as defined in claim 15, wherein the graphical user interface displays the one or more facility equipment operating status details in a manner representing hard-copy pages of a user manual.
